(19) United States
(12) Patent Application Publication
(10) Pub. No.: US 2016/0194539 A1
(43) Pub. Date: Jul. 7, 2016

(54) Polishing Material, Polishing Material Slurry

(71) Applicant: KONICA MINOLTA, INC., Chiyoda-ku, Tokyo (JP)

(72) Inventors: Yuuki NAGAI, Tachikawa-shi, Tokyo (JP); Akihiro MAEZAWA, Hino-shi, Tokyo (JP); Chie INUI, Hino-shi, Tokyo (JP); Natsumi HIRAYAMA, Hino-shi, Tokyo (JP)

(21) Appl. No.: 14/911,224

(22) PCT Filed: Jul. 25, 2014
(86) PCT No.: PCT/JP2014/069744

§ 371 Date: Feb. 9, 2016

(30) Foreign Application Priority Data
Aug. 9, 2013 (JP) 2013-166489

(51) Int. Cl. C09K 3/14; C09G 1/02

(52) U.S. Cl. CPC C09K 3/1409; C09G 1/02; C09K 3/1463

(57) ABSTRACT

A polishing material comprising a polishing material particle including cerium, wherein, the polishing material particle is a secondary particle obtained by baking a primary particle which is a polishing material precursor particle; the primary particle is a sphere shape; an average particle size of the primary particle is within a range of 100 to 1000 nm; and an average particle size of the secondary particle is within a range of 300 to 10000 nm.

### TECHNICAL FIELD

The present invention relates to polishing material and polishing material slurry. Specifically, the present invention relates to polishing material and polishing material slurry in which productivity and polishing performance are enhanced.

### BACKGROUND ART

In precision polishing in a process of producing glass optical elements, glass substrates, and semiconductor devices, polishing materials composed of oxides of rare earth elements, mainly composed of cerium oxide and additionally containing lanthanum oxide, neodymium oxide, praseodymium oxide, and/or oxides of other rare earth elements, have been traditionally used. Although other polishing materials, for example, diamond, iron oxide, aluminum oxide, zirconium oxide, and colloidal silica are also known, cerium oxide has been widely used from the viewpoint of the high polishing rate and the surface flatness of polished workpieces.

Cerium oxide typically distributed as polishing material is usually made from a crushing method. However, polishing material made from the crushing method has edges on the surface. Therefore, the polishing rate is fast but scratches are often made.

Moreover, in a producing method in which there is a demand for smoothness with a high angstrom (A) level, usually, polishing is performed using colloidal silica with a size of a few tens of nm after polishing in advance with cerium oxide with a high polishing rate.

However, there is a problem that productivity reduces due to many levels in the polishing step. Moreover, there is a higher demand for smoothness, and there is a demand for a sphere shaped polishing material which maintains a high polishing rate while hardly causing scratches.

Patent Literature 1 describes a polishing material in which 90% or more of the entire polishing material slurry includes cerium oxide in which a particle size distribution is adjusted within a range of 100 to 800 nm as polishing material which hardly causes scratches.

However, there is a problem that such polishing material slurry cannot achieve a sufficient polishing rate.

### PRIOR ART DOCUMENT

### Patent Literature

Patent Literature 1: Japanese Patent Application Laid-Open Publication No. 2004-291232

### SUMMARY OF INVENTION

### Problems to be Solved by the Invention

The present invention is made in view of the above problems and situation, and the problems to be solved by the present invention is to provide polishing material and polishing material slurry including a polishing material particle with high productivity suitable for fine polishing.

### Means for Solving the Problem

In order to solve the above-described problems, while considering the reasons of the above problem, the inventors found that the relation between the size of a prepared polishing material precursor particle (primary particle) and a size of a secondary particle aggregating the primary particle after baking is important in order to obtain a polishing material and a polishing material slurry including a polishing material particle with high productivity suitable for fine polishing.

In other words, the above described problems regarding the present invention is solved by the following.

1. A polishing material including:

a polishing material particle including cerium,

wherein, the polishing material particle is a secondary particle obtained by baking a primary particle which is a polishing material precursor particle;

the primary particle is a sphere shape;

an average particle size of the primary particle is within a range of 100 to 1000 nm; and

an average particle size of the secondary particle is within a range of 300 to 10000 nm.

2. The polishing material of aspect 1, wherein a particle size variation coefficient of the polishing material particle included in the polishing material is 25% or less.

3. Polishing material slurry including polishing material according to aspect 1 or aspect 2.

### Advantageous Effects of Invention

Polishing material and polishing material slurry including a polishing material particle with high productivity suitable for fine polishing can be provided according to the above.

The reason for such advantageous effects of the present invention is not clear, but it is thought to be as follows.

According to the polishing material of the present invention, by adjusting the size of the primary particle which is a polishing material precursor and the size of the secondary particle which is the aggregated state after baking, the workpiece can be polished with different polishing performance in the beginning step of the polishing process and the final step of the polishing process.

The industrial idea is considered to be, in the beginning step of the polishing process, the workpiece needs to be greatly scraped, and therefore, the secondary particle in the aggregated state having the large average particle size is suitable for the polishing process. On the other hand, in the final step of the polishing process, the workpiece becomes close to the desired flatness, and the polishing material particle becomes closer to the primary particle than the secondary particle in the aggregated state by polishing the workpiece.

With this, the following effects can be achieved, the aggregated state of the polishing material particle itself changes from the beginning step of the polishing process by performing the polishing process so that the average particle size becomes small, fine polishing can be performed, and the steps become more simple.

### BRIEF DESCRIPTION OF DRAWINGS

FIG. 1 is an example of a scanning electron microscopic picture of a polishing material particle of the present invention.

FIG. 2 is an example of a scanning electron microscopic picture of a polishing material particle of the present invention.

### EMBODIMENT FOR CARRYING OUT THE INVENTION

The polishing material of the present invention is a polishing material including a polishing material particle including cerium, the polishing material particle is a secondary particle obtained by baking a primary particle which is a polishing material precursor particle, the primary particle is sphere shaped, the average particle size of the primary particle is within the range of 100 to 1000 nm, and the average particle size of the secondary particle is within the range of 300 to 10000 nm.

Such features are the technical features common throughout the invention of the first to third aspect.

Preferably, according to the present invention, a particle size variation coefficient of the polishing material particle included in the polishing material is 25% or less. Since polishing can be performed with polishing particles having a uniform particle size, it is possible to achieve the following effects, the productivity is enhanced and scratches are hardly made.

Preferably, the polishing material slurry of the present invention includes the polishing material of the present invention so that excellent fine polishing can be performed.

Below, the existing polishing material, and the polishing material particle included in the polishing material of the present invention, the producing method of the polishing material and the polishing process are described in detail. In the present description, “to” is used including the values described before and after the “to” as the bottom limit and the top limit.

### <Polishing Material>

A typical polishing material is slurry of polishing material particles, for example, iron oxide (αFe₂O₃), cerium oxide, aluminum oxide, manganese oxide, zirconium oxide, or colloidal silica dispersed in water or oil. The present invention relates to a polishing material particle and polishing material slurry including the polishing material composed of cerium oxide that can be applied to chemical mechanical polishing (CMP) that polishes a workpiece by physical and chemical actions for achieving a sufficient polishing rate, while maintaining a flatness with high accuracy in the process of polishing a semiconductor device or glass. The details will now be described.

### <Polishing Material Particle>

The polishing material of the present invention is a polishing material including a polishing material particle including cerium, the polishing material particle is a secondary particle obtained by baking a primary particle which is a polishing material precursor particle, the primary particle is sphere shaped, the average particle size of the primary particle is within the range of 100 to 1000 nm, and the average particle size of the secondary particle is within the range of 300 to 10000 nm.

Here, “primary particle” is a polishing material precursor particle (hereinafter referred to as precursor of polishing material particle) before baking. The average particle size of the primary particle is within the range of 100 to 1000 nm.

On the other hand, “secondary particle” is a polishing material particle aggregated in the step of baking the polishing material precursor particle. The average particle size of the secondary particle is to be within the range of 300 to 10000 nm.

The adjustment of the average particle size of the primary particle and the secondary particle can be performed by the following, the adjustment of the amount of the material of the component composing the polishing material particle, the adjustment of the reaction time in the polishing material precursor particle producing step, and the adjustment of the baking temperature and time of the polishing material precursor particle.

Preferably, the composition of the polishing material particle included in the polishing material of the present invention is the following, for example, a total amount of cerium (Ce) and at least one type of element selected from lanthanum (La), praseodymium (Pr), neodymium (Nd), samarium (Sm), and europium (Eu) is 81 mol % or more with respect to a total amount of the rare earth elements included in the polishing material particle, and an amount of at least one type of element selected from yttrium (Y), gadolinium (Gd), terbium (Tb), dysprosium (Dy), holmium (Ho), erbium (Er), thulium (Tm), ytterbium (Yb), and lutetium (Lu) is 19 mol % or less with respect to the total amount of the rare earth elements included in the polishing material particle. With this, a sphere-shaped polishing material particle can be obtained.

The polishing material particle is to always include cerium, and a few types of elements should be suitably included according to the intended performance of the polishing material.

The polishing material particle can include a layer configuration or can be a one layer configuration without distinction of layers.

As a polishing material including a layer configuration, there is a core-shell configuration with a layer including a center as a core, and a layer on the outside excluding the core as a shell.

In a core-shell configuration, the type of element included in each layer and the amount can be suitably set according to the intended polishing material.

For example, the polishing material particle can be prepared including a core-shell configuration in which the core is a layer with yttrium as the main component, and the shell includes cerium as the main component. In this case, for example, in addition to cerium and yttrium, at least one type of element selected from lanthanum, praseodymium, neodymium, samarium, europium, gadolinium, terbium, dysprosium, holmium, erbium, thulium, ytterbium, and lutetium can be included in each layer.

Here, the amount of rare earth elements of the polishing material particle included in the polishing material can be obtained by element analysis. For example, 1 g is dissolved in a mixed solution including 10 ml of nitric acid aqueous solution and 1.0 ml of hydrogen peroxide water, and element analysis is performed using ICP emission spectrometry plasma apparatus (ICP-AES) manufactured by SII NanoTechnology Inc. The composition ratio (mol %) can be obtained from the amount of the rare earth materials of the polishing material particle.

The composition distribution of the polishing material particle can be obtained by performing element analysis of the cross section of the polishing material particle. For example, cross section processing is performed on the polishing material particle by a focusing ion beam (FB-2000A) manufactured by Hitachi High-Technologies Corporation, and a face passing near the center of the particle is cut out. STEM-EDX (HD-2000) of Hitachi High-Technologies Corporation is used to perform element analysis of the cut face and the composition distribution of the rare earth elements of the polishing material particle can be obtained.

Here, a sphere shape (ball shape) is defined based on scanning electron microscopic picture (SEM image) of the polishing material particle.

Specifically, a scanning electron microscopic picture of the polishing material particle is captured, and 100 polishing material particles are selected randomly. A major axis of the selected polishing material particle is to be a, a minor axis is to be b, and an average value of a/b is obtained as an aspect ratio. When a circumscribed rectangle of the particles is drawn, among the short sides and the long sides of the circumscribed rectangle, the length of the shortest short side is to be the minor axis, and the length of the longest long side is to be the major axis.

The shape is classified as a sphere shape when the aspect ratio is within the range of 1.00 to 1.15, preferably, 1.00 to 1.05. The shape is classified as an indeterminate form when outside the range of 1.00 to 1.15.

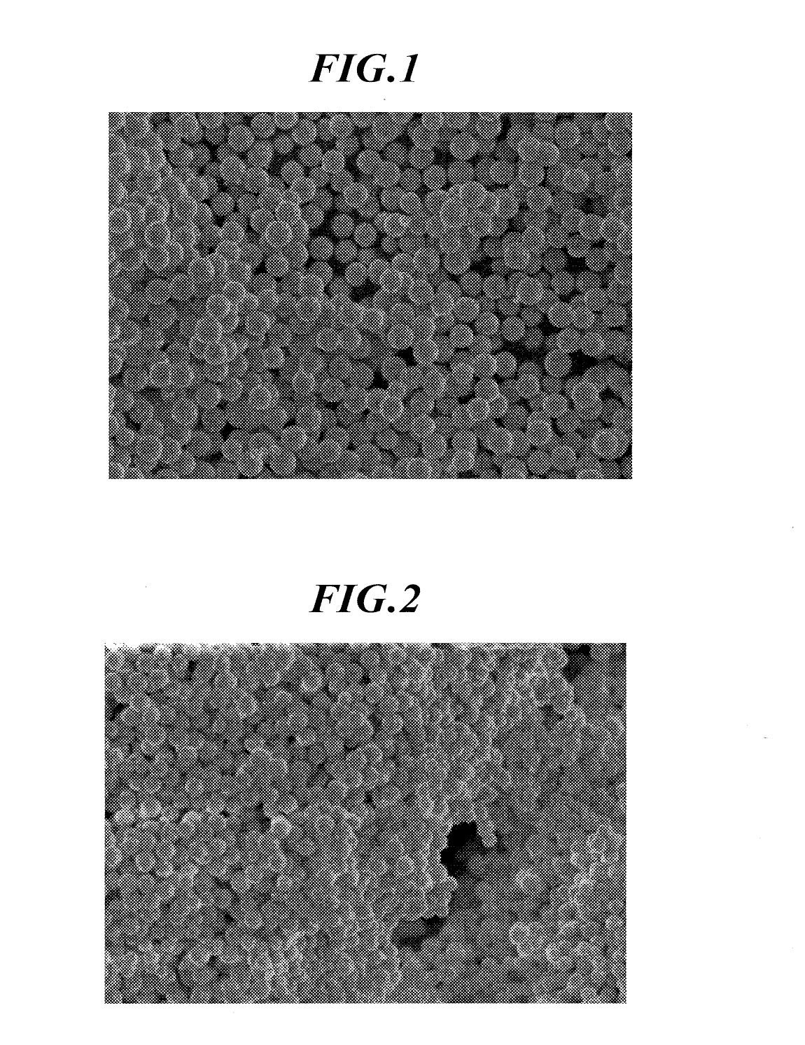

The aspect ratio closer to 1 shows the degree of sphericity is higher. The polishing material including the polishing material particle of the present invention with the high degree of sphericity is suitable for fine polishing, has a high polishing rate, and has high productivity. This shows the polishing material is excellent. FIG. 1 shows a picture (magnification rate 10000 times) capturing a primary particle of the polishing material particle of the present invention captured with a scanning electron microscope. This shows the sphere shape and high monodispersity. FIG. 2 shows the SEM image (magnification rate 10000 times) of the secondary particle of the polishing material particle. This shows the secondary particle is aggregated after baking.

The average particle size of the primary particle is obtained by the following. Based on the square measure of the picture image of the particles from the SEM image of 20 polishing material particles, the particle size corresponding to the square measure circle is obtained. This is to be the particle size of the particles.

The average particle size is the arithmetic average value of the particle size of the 20 polishing material particles.

The measurement of the particle size can be performed using the image processing measurement apparatus (for example, LUZEX AP manufactured by NIRECO CORPORATION).

Moreover, the average particle size before and after the polishing process and the monodispersity of the secondary particle can be obtained using the particle size distribution measurement.

In the particle size distribution measurement, for example, the secondary particle after crushing is dispersed in water and a suitable amount is put into the apparatus. It is known that when a laser hits a particle in the dispersion medium, the laser scatters at a refractive index and magnitude unique to the particle type (here, cerium) and particle size according to the light scattering theory. This principle can be used to calculate the average particle size before and after the polishing process.

The monodispersity of the secondary particle can be defined by the variation coefficient of the particle size distribution which can be calculated using the particle size obtained from the particle size distribution measurement.

The particle size distribution variation coefficient can be obtained by the following equation.

Variation coefficient (%)=(standard deviation of particle size distribution/average particle size)·100

As a method of extracting particles with about the same secondary particle size and different monodispersity, for example, a particle group with a low monodispersity dispersed in water is placed in a cylindrical container, and liquid is taken out from a central portion in the perpendicular direction of the cylinder to obtain the secondary particle group with about the same size.

The polishing rate of the polishing material particle according to the present invention can be measured by polishing a polishing target face with a polishing cloth while supplying on the polishing target face of the polisher the polishing material slurry in which powder of the polishing material including the polishing material particle is dispersed in the solution such as water.

For example, the polishing rate can be measured by supplying by circulation the polishing material slurry to the polisher and performing the polishing process for 30 minutes. The thickness before and after polishing is measured with Nikon Digimicro (MF501), the polishing amount (mm) for each minute is calculated from the change in thickness and this is to be the polishing rate.

The average polishing amount for 5 minutes after the start of the polishing process is calculated as the initial polishing rate, and the polishing amount for 5 minutes from 5 minutes before the polishing process ends to when the process ends can be calculated as the end polishing rate.

Specifically, from the viewpoint of productivity, the initial polishing rate needs to be 0.50 mm/min or more and the end polishing rate needs to be 0.10 mm/min or more.

Preferably, the monodispersity of the particle size of the polishing material particle of the present invention is 25% or less.

The polishing material including the polishing material particle showing high monodispersity hardly causes scratches and is suitable for fine polishing.

Here, the state of the scratches can be obtained by evaluating the surface state of the glass substrate.

For example, regarding the surface state (surface roughness Ra) of the glass substrate surface, the surface roughness of the glass substrate on which the polishing process is performed for 30 minutes can be evaluated by light wave interference surface roughness measurement device (Dual-channel Zemapper manufactured by Zygo). Ra shows the arithmetic average roughness in JIS B0601-2001.

Regarding the surface state (number of scratches) of the glass substrate surface, the number of scratches can be evaluated by measuring the unevenness of the entire surface of the glass substrate on which the polishing process is performed for 30 minutes using the light wave interference surface roughness measurement device (Dual-channel Zemapper manufactured by Zygo).

Specifically, from the viewpoint of practical use, the number of scratches needs to be no more than 20, preferably no more than 10.

### <Producing Method of Polishing Material>

The method of producing the polishing material is described below.

The producing method of the polishing material including the polishing material particle of the present invention includes at least the polishing material precursor preparing step, solid-liquid separating step, and baking step.

Specifically, the detailed process in the polishing material precursor particle preparing step is different depending on the structure of layers or composition of the polishing material particle to be prepared.

As one example, the producing method of the polishing material particle including cerium with a layered structure and the producing method of the polishing material particle including cerium without a layered structure are described.

### [Producing Method of Polishing Material Particle Including Layered Structure]

As the producing method of the polishing material particle with the layered structure, the producing method of the polishing material particle including a core and shell is described below.

The producing method of the polishing material particle with the layered structure includes the following 4 steps, core forming step, shell forming step, solid-liquid separating step and baking step.

### 1. Core Forming Step

In the core forming step, for example, a salt of at least one element selected from the group consisting of aluminum (Al), scandium (Sc), titanium (Ti), vanadium (V), chromium (Cr), manganese (Mn), iron (Fe), cobalt (Co), nickel (Ni), copper (Cu), zinc (Zn), gallium (Ga), germanium (Ge), zirconium (Zr), indium (In), tin (Sn), yttrium (Y), gadolinium (Gd), terbium (Tb), dysprosium (Dy), holmium (Ho), erbium (Er), thulium (Tm), ytterbium (Yb), lutetium (Lu), tungsten (W), bismuth (Bi), thorium (Th), and alkali earth metals is formed, and a core of the polishing material precursor particle mainly consisting of the salt of the above elements is formed.

Specifically, in the core forming step, salt of yttrium and precipitant are dissolved in water to prepare a solution with a predetermined concentration. Then, in the core forming step, the prepared solution is heated at 80 C or more and mixed, and forms a basic carbonate which does not dissolve in water and which becomes the core of the polishing material precursor particle.

Here, the core is the region including the central portion of the polishing material precursor particle. Although the shape of the region is not limited, preferably, the shape is a sphere shape.

In the description below, the solution in which the heating and mixing is started is to be the reaction solution.

In the core forming step, the salt of at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkali earth metals which is dissolved in water may be, for example, nitrate, hydrochloride, or sulfate, and preferred is nitrate since few impurities are mixed in the product.

Moreover, as the precipitant, any type of alkaline compound which generates basic carbonate when mixed and heated in water with the salt of the element can be used. Preferable examples include an urea aqueous solution or an aqueous solution prepared from an urea compound, ammonium carbonate, ammonium bicarbonate and the like. Examples of the urea compound include salts of urea (e.g., nitrate and hydrochloride), N,N′-dimethylacetylurea, N,N′-dibenzoylurea, benzenesulfonylurea, p-toluenesulfonylurea, trimethylurea, tetraethylurea, tetramethylurea, triphenylurea, tetraphenylurea, N-benzoylurea, methylisourea, ethylisourea, and ammonium bicarbonate.

Specifically, urea is preferable among the urea compounds, because precipitate is slowly generated by gradually hydrolyzing and even precipitate can be obtained.

Moreover, by adding the precipitant, basic carbonate which does not dissolve in water, such as basic carbonate of yttrium is generated so that deposited precipitate can be dispersed in a state of monodispersion. Basic carbonate of cerium is formed in the shell forming step described below, and therefore, a successive layer configuration can be formed with the basic carbonate.

In the following embodiment, the aqueous solution added in the reaction solution in the core forming step and the shell forming step is an yttrium nitrate aqueous solution prepared by dissolving in water yttrium nitrate as the salt of the at least one element selected from the group consisting of Al, Sc, Ti, V, Cr, Mn, Fe, Co, Ni, Cu, Zn, Ga, Ge, Zr, In, Sn, Y, Gd, Tb, Dy, Ho, Er, Tm, Yb, Lu, W, Bi, Th, and alkali earth metals. Moreover, urea is used as the urea compound but is merely an example, and the present invention should not be limited to the example.

Preferably, in the core forming step, the adding rate of the aqueous solution including yttrium is 0.003 mol/L to 5.5 mol/L for each minute, and the aqueous solution is added in the reaction solution while heating at 80 C or more and mixing. By setting the adding rate within the above range, spherical polishing material particles showing high monodispersion properties are easily formed. When the heating temperature in heating and mixing is set to 80 C or more, the decomposition of the added urea easily progresses. Preferably, the concentration of the added urea is a concentration 5 to 50 times the ion concentration of the yttrium. By setting the urea concentration and the ion concentration in the yttrium aqueous solution within the above range, spherical polishing material particles showing monodispersion properties can be synthesized.

The mixer in the heating and mixing may have any shape and other factors that can provide a sufficient mixing efficiency. In order to achieve a higher mixing efficiency, an axial flow mixer of a rotor stator type is preferably used.

### 2. Shell Forming Step

In the shell forming step, an aqueous solution prepared with yttrium nitrate and cerium nitrate is added for a predetermined amount of time at a certain rate in a reaction solution in which, for example, basic carbonate of yttrium formed in the core forming step is dispersed and the shell of the polishing material precursor particle including yttrium basic carbonate and cerium basic carbonate is formed on the outer side of the core.

Cerium nitrate is used here since it is preferable to use nitrate in which impurities are hardly mixed in the product as the salt of the cerium used in preparing the aqueous solution. However, the example is not limited to the above, and hydrochloride, sulfate and the like can be used.

Preferably, the adding rate of the aqueous solution added in the shell forming step is 0.003 mol/L to 5.5 mol/L each minute. Here, the adding rate is set to the above range so that spherical polishing material particle with high monodispersion properties is easily formed.

Moreover, preferably, the reaction solution is heated at 80 C or more and mixed while the aqueous solution is added at the above adding rate. This is because when the reaction solution is heated at 80 C or more and mixed, the decomposition of the urea added in the core forming step easily progresses.

In the shell forming step, the aqueous solution prepared at a predetermined density including yttrium and cerium is added to the reaction solution for a predetermined amount of time, and with this, the composition of the cerium in the reaction solution successively increases. Specifically, in the composition of the reaction solution in the shell forming step, the composition ratio of cerium in the reaction solution increases after starting the adding of the aqueous solution and the composition ratio of yttrium decreases. After a predetermined amount of time after starting the heating and mixing, if the aqueous solution is continuously added, the composition ratio between the yttrium and cerium in the added aqueous solution becomes closer. The shell formed in the shell forming step is formed in the composition ratio between yttrium and cerium corresponding to the change in the composition of the reaction solution.

The aggregation state of the primary particle, in other words, the average particle size of the secondary particle can be adjusted by the size, baking time, and baking temperature of the polishing material precursor particle generated in the core forming step and the shell forming step.

The average particle size of the secondary particle after baking can be adjusted to the desired average particle size by crushing.

### 3. Solid-Liquid Separating Step

In the solid-liquid separating step, after heating and mixing, the generated precipitate (precursor of the polishing material fine particle) is separated from the reaction solution. The method of solid-liquid separation can be any typical method, for example, the polishing material precursor particle can be obtained by filtration using a filter.

### 4. Baking Step

In the baking step, the polishing material precursor particle obtained by the solid-liquid separating step is baked in an oxidizing atmosphere at a baking temperature of 1500° C. or higher for 3 hours. Preferably, a roller hearth kiln is used as the baking device.

In order to prevent fine cracks in the polishing material particle, the increase and decrease from and to the room temperature in the baking step is performed at a speed of 25 C/min. The baked polishing material precursor particle becomes an oxide and becomes a secondary particle including cerium oxide.

Cleaning with water or alcohol or drying can be performed as necessary before baking.

The polishing material particle is stabilized by cooling after baking, and then the above is collected as the polishing material including the polishing material particle.

### 5. Crushing Step

The crushing step is the step to crush the secondary particle obtained in the baking step to adjust the particle to the desired average particle size. Specifically, the obtained secondary particle can be crushed using a crushing sifter.

For example, a bead mill can be used as the crushing filter, and with this, the polishing material can be obtained with the secondary particle crushed to the desired average particle size.

[Producing Method of Polishing Material Particle without Layered Structure]

The producing method of the polishing material particle without the layered structure basically consists of the following six steps 1 to 6. The carbon dioxide can be introduced continuously or intermittently from steps 1 to 4, preferably at least from steps 2 to 3.

By continuously or intermittently introducing carbon dioxide in the aqueous solution or the reaction solution, it is possible to control the carbonate ion concentration within a desired range.

Here, continuously means introducing the carbon dioxide in the reaction solution at a certain flow amount and pressure from the beginning to the end of the introduction of the carbon dioxide.

Turning to intermittently, this means the carbon dioxide is introduced in the reaction solution with a predetermined interval at a predetermined flow amount and pressure from the beginning to the end of the introduction of the carbon dioxide. The interval can be suitably set according to the flow amount and pressure.

For example, the carbonate ion concentration in the aqueous solution or the reaction solution right before the precipitant is added in step 2 is preferably within the range of 50 to 1600 mg/L, specifically 58 to 1569 mg. With this, sufficient amount of carbon dioxide can be introduced in the reaction solution, and the supply amount of the carbon dioxide can be controlled.

### 1. Step 1 (Rare Earth Aqueous Solution Preparing Step)

In step 1 (rare earth aqueous solution preparing step), the aqueous solution including cerium (Ce) is prepared and heated.

Specifically, first, the aqueous solution including cerium is prepared.

For example, an aqueous solution as follows is prepared, an aqueous solution in which the amount of cerium is 95 to 100 mol % with respect to the entire amount of rare earth elements included in the aqueous solution, or an aqueous solution always including cerium and including at least one element selected from a group of lanthanum, praseodymium, neodymium, samarium, europium, yttrium, gadolinium, terbium, dysprosium, holmium, erbium, thulium, ytterbium, and lutetium.

Preferably, the ion concentration in the aqueous solution in which the amount of cerium is 95 to 100 mol % with respect to the entire amount of rare earth elements included in the aqueous solution, or the aqueous solution always including cerium and including at least one element selected from a group of lanthanum, praseodymium, neodymium, samarium, europium, yttrium, gadolinium, terbium, dysprosium, holmium, erbium, thulium, ytterbium, and lutetium is 0.001 mol/L to 0.1 mol/L, and the concentration of urea is 5 to 50 times the ion concentration.

The ion concentration and the ion concentration of urea in the aqueous solution including only cerium, or the aqueous solution always including cerium and including at least one element selected from a group of lanthanum, praseodymium, neodymium, samarium, europium, yttrium, gadolinium, terbium, dysprosium, holmium, erbium, thulium, ytterbium, and lutetium are set within the above range because it is assumed that this enables synthesizing of the polishing material particle in a sphere shape showing monodispersity.

The salt of the above elements which can be used to prepare the aqueous solution include, nitrate, hydrochloride, or sulfate, and preferred is nitrate. With this, polishing material with few impurities can be made.

### 2. Step 2 (Precipitant Adding Step)

In step 2 (precipitant adding step), the precipitant is added to the aqueous solution heated in step 1 to prepare a reaction solution.

Preferably, the precipitant is urea or an urea compound because carbon dioxide and ammonia can be supplied by hydrolysis reaction.

Specifically, for example, in step 2 (precipitant adding step), an urea aqueous solution with a predetermined concentration is prepared in advance and the urea aqueous solution is heated and added.

For example, 0.5 L of urea aqueous solution at 5.0 mol/L is prepared and heated to 60 C.

By heating at 60 C or less, the urea can be held without hydrolysis, and when the aqueous solution heated in step 1 is added, the reaction can progress without drastically decreasing the temperature of the reaction solution.

Instead of the urea aqueous solution, the aqueous solution prepared with the urea compound used in the core forming step can be used. In the embodiments below, the basic carbonate is formed using the urea aqueous solution, but this is one example, and the present invention is not limited to the above.

Here, preferably, the urea aqueous solution is added at a higher adding rate. Specifically, preferably, the adding rate of the urea aqueous solution is 0.5 L/min or more, and specifically, 1.0 L/min or more. By increasing the adding rate of the urea aqueous solution, the core of the polishing material particle generated by the urea aqueous solution can grow in a sphere shape without anisotropic growth.

### 3. Step 3 (Polishing Material Precursor Particle Generating Step)

In step 3 (polishing material precursor particle generating step), the reaction solution is heated and mixed to generate the polishing material precursor particle.

Specifically, the mixed solution is mixed while heating.

By mixing the urea aqueous solution and the rare earth aqueous solution, the core of the polishing material particle is generated and dispersed in the mixed solution. By heating and mixing the mixed solution in which the core of the polishing material particle is dispersed, the core of the polishing material grows and the polishing material precursor can be obtained.

The rare earth aqueous solution and the urea aqueous solution are reacted so that the polishing material precursor particle is generated as the basic carbonate.

Preferably, the heating temperature in heating is 80 C or more, more preferably 90 C or more. Preferably, the mixing time is 1 hour or more and 10 hours or less, and more preferably 1 hour or more and 3 hours or less. The heating temperature and mixing time can be suitably adjusted according to the target particle size.

The average particle size of the polishing material precursor particle (primary particle) can be adjusted with the size of the core of the polishing material particle or the temperature that the reaction solution of the rare earth aqueous solution and the urea aqueous solution is heated and the mixing time. Since the sintering state can be changed by adjusting the baking temperature and the baking time, the aggregation state of the secondary particle, in other words, the average particle size of the secondary particle can also be adjusted.

The mixer in the heating and mixing may have any shape and other factors that can provide a sufficient mixing efficiency. In order to achieve a higher mixing efficiency, a mixer of a rotor stator type is preferably used.

### 4. Step 4 (Solid-Liquid Separating Step)

In step 4 (solid-liquid separating step), the polishing material precursor particle can be obtained by the same solid-liquid separating operation as the producing method of the polishing material particle with the layered structure.

### 5. Step 5 (Baking Step)

In step 5 (baking step), the polishing material particle including cerium oxide can be obtained by the same baking operation as the producing method of the polishing material particle with the layered structure.

The polishing material particle is stabilized by cooling after baking, and then the above is collected as the polishing material including the polishing material particle.

The polishing material includes 50% by mass or more of the polishing material particle, preferably 70% by mass or more, and more preferably 90% by mass or more. With this, polishing material with a small surface roughness due to polishing can be obtained.

### 6. Step 6 (Crushing Step)

In step 6 (crushing step), by crushing operation the same as the producing method of the polishing material particle with the layered structure, the polishing material in which the secondary particle is crushed to the desired average particle size can be obtained.

### <Polishing Process Method>

A method of using the polishing material will now be described by a polishing process of a glass substrate for an information recording disk as an example.

### 1. Preparation of Polishing Material Slurry

A slurry of a polishing material is prepared by adding a powder of the polishing material including the polishing material particle to a solvent such as water. Aggregation is prevented by adding, for example, a dispersant to the polishing material slurry, and the dispersion state is maintained by constantly mixing the slurry with a mixer or the like. The slurry of the polishing material is circularly supplied to a polisher with a supply pump.

### 2. Polishing Step

A glass substrate is brought into contact with the upper and lower surface plates of a polisher provided with polishing pads (polishing cloth). Polishing is performed by relatively moving the pads and the glass under a pressurized condition, while the slurry of the polishing material is supplied to the contact surfaces.

### Examples

The polishing material producing method will now be specifically described, but should not be construed to limit the scope of the invention in any way. In the example “parts” or “%” is used, but this represents “parts by mass” or “% by mass” respectively unless otherwise noted.

The polishing material precursor particle before baking is to be the primary particle, the average particle size is adjusted by crushing the secondary particle obtained from baking, the average particle size of each of the above is obtained by the later described method, and the result is shown in table 1.

### <Polishing Material 1>

(1) 10 L of water was prepared so that yttrium nitrate aqueous solution was 0.01 mol/L and urea was 0.25 mol/L. The above was sufficiently mixed and then heating at 90 C with mixing was started.

(2) Yttrium nitrate aqueous solution with 1.0 mol/L was added to the aqueous solution of (1) at an adding rate of 1 mL each minute for 4 minutes.

(3) Nitrate aqueous solution including 0.1 mol/L of yttrium and 0.9 mol/L of cerium was added to the aqueous solution of (2) at an adding rate of 1 mL each minute for 4 minutes.

(4) The polishing material precursor particle deposited in the above (3) is separated with the membrane filter and baked at 1500 C for 3 hours, at a temperature increase/decrease rate of 25 C/min (during increase from room temperature and decrease to room temperature) to obtain the secondary particle with 15000 nm.

(5) The secondary particle obtained in (4) is crushed to adjust the average particle size and the secondary particle with the average particle size of 150 nm is obtained.

(6) The particle size distribution measurement is performed on the secondary particle obtained in (5) with the adjusted average particle size so that the distribution is adjusted to a similar particle size to enhance monodispersity (CV value). Specifically, the particle group with the low monodispersity dispersed in water is put into a cylindrical container, and the liquid is taken out from the center portion of the cylinder in the perpendicular direction to obtain the secondary particle group with the similar size. The monodispersity of the following polishing material is also enhanced with a similar method.

### <Polishing Materials 2 to 4>

The producing method of the polishing materials 2 to 4 is the same as the polishing material 1, except when the secondary particle is crushed in (5), the average particle size is adjusted to be a secondary particle at 250 nm, 5000 nm, 10000 nm, respectively.

### <Polishing Material 5>

(1) 10 L of water was prepared so that yttrium nitrate aqueous solution was 0.01 mol/L and urea was 0.25 mol/L. The above was sufficiently mixed and then heating at 90 C with mixing was started.

(2) Yttrium nitrate aqueous solution with 1.0 mol/L was added to the aqueous solution of (1) at an adding rate of 1 mL each minute for 5 minutes.

(3) Nitrate aqueous solution including 0.1 mol/L of yttrium and 0.9 mol/L of cerium was added to the aqueous solution of (2) at an adding rate of 1 mL each minute for 5 minutes.

(4) The polishing material precursor particle deposited in the above (3) is separated with the membrane filter and baked at 1500 C for 3 hours, at a temperature increase/decrease rate of 25 C/min to obtain the secondary particle with 15000 nm.

(5) The secondary particle obtained in (4) is crushed to adjust the average particle size and the secondary particle with the average particle size of 150 nm is obtained.

### <Polishing Materials 6 to 9>

The producing method of the polishing materials 6 to 9 is the same as the polishing material 5, except when the secondary particle is crushed in (5), the average particle size is adjusted to be a secondary particle at 300 nm, 1000 nm, 5000 nm, 10000 nm, respectively.

### <Polishing Material 10>

(1) 10 L of water was prepared so that yttrium nitrate aqueous solution was 0.01 mol/L and urea was 0.25 mol/L. The above was sufficiently mixed and then heating at 90 C with mixing was started.

(2) Yttrium nitrate aqueous solution with 1.0 mol/L was added to the aqueous solution of (1) at an adding rate of 1 mL each minute for 25 minutes.

(3) Nitrate aqueous solution including 0.1 mol/L of yttrium and 0.9 mol/L of cerium was added to the aqueous solution of (2) at an adding rate of 1 mL each minute for 25 minutes.

(4) The polishing material precursor particle deposited in the above (3) is separated with the membrane filter and baked at 1500 C for 3 hours, at a temperature increase/decrease rate of 25 C/min to obtain the secondary particle with 15000 nm.

(5) The secondary particle obtained in (4) is crushed to adjust the average particle size and the secondary particle with the average particle size of 1000 nm is obtained.

(6) The particle size distribution measurement is performed on the secondary particle obtained in (5) with the adjusted average particle size so that the distribution is adjusted to a similar particle size to enhance monodispersity (CV value).

<Polishing material 11>

(1) 10 L of water was prepared so that yttrium nitrate aqueous solution was 0.01 mol/L and urea was 0.25 mol/L. The above was sufficiently mixed and then heating at 90 C with mixing was started.

(2) Yttrium nitrate aqueous solution with 1.0 mol/L was added to the aqueous solution of (1) at an adding rate of 1 mL each minute for 25 minutes.

(3) Nitrate aqueous solution including 0.1 mol/L of yttrium and 0.9 mol/L of cerium was added to the aqueous solution of (2) at an adding rate of 1 mL each minute for 25 minutes.

(4) The polishing material precursor particle deposited in the above (3) is separated with the membrane filter and baked at 1500 C for 3 hours, at a temperature increase/decrease rate of 25 C/min to obtain the secondary particle with 15000 nm.

(5) The secondary particle obtained in (4) is crushed to adjust the average particle size and the secondary particle with the average particle size of 1000 nm is obtained.

### <Polishing Materials 12, 13>

The producing method of the polishing materials 12 and 13 is the same as the polishing material 10, except when the secondary particle is crushed in (5), the average particle size is adjusted to be a secondary particle at 5000 nm, 10000 nm, respectively.

### <Polishing Material 14>

(1) 10 L of water was prepared so that yttrium nitrate aqueous solution was 0.01 mol/L and urea was 0.25 mol/L. The above was sufficiently mixed and then heating at 90 C with mixing was started.

(2) Yttrium nitrate aqueous solution with 1.0 mol/L was added to the aqueous solution of (1) at an adding rate of 1 mL each minute for 25 minutes.

(3) Nitrate aqueous solution including 0.1 mol/L of yttrium and 0.9 mol/L of cerium was added to the aqueous solution of (2) at an adding rate of 1 mL each minute for 25 minutes.

(4) The polishing material precursor particle deposited in the above (3) is separated with the membrane filter and baked at 1500 C for 3 hours, at a temperature increase/decrease rate of 25 C/min to obtain the secondary particle with 15000 nm.

(5) The secondary particle obtained in (4) is crushed to adjust the average particle size and the secondary particle with the average particle size of 10000 nm is obtained.

### <Polishing Material 15>

The producing method of the polishing material 15 is the same as the polishing material 10, except when the secondary particle is crushed in (5), the average particle size is adjusted to be a secondary particle at 15000 nm.

<Polishing material 16>

(1) 10 L of water was prepared so that yttrium nitrate aqueous solution was 0.01 mol/L and urea was 0.25 mol/L. The above was sufficiently mixed and then heating at 90 C with mixing was started.

(2) Yttrium nitrate aqueous solution with 1.0 mol/L was added to the aqueous solution of (1) at an adding rate of 1 mL each minute for 50 minutes.

(3) Nitrate aqueous solution including 0.1 mol/L of yttrium and 0.9 mol/L of cerium was added to the aqueous solution of (2) at an adding rate of 1 mL each minute for 50 minutes.

(4) The polishing material precursor particle deposited in the above (3) is separated with the membrane filter and baked at 1500 C for 3 hours, at a temperature increase/decrease rate of 25 C/min to obtain the secondary particle with 15000 nm.

(5) The secondary particle obtained in (4) is crushed to adjust the average particle size and the secondary particle with the average particle size of 5000 nm is obtained.

(6) The particle size distribution measurement is performed on the secondary particle obtained in (5) with the adjusted average particle size so that the distribution is adjusted to a similar particle size to enhance monodispersity (CV value).

### <Polishing Materials 17, 18>

The producing method of the polishing materials 17 and 18 is the same as the polishing material 16, except when the secondary particle is crushed in (5), the average particle size is adjusted to be a secondary particle at 10000 nm, 15000 nm, respectively.

<Polishing material 19>

(1) 10 L of water was prepared so that yttrium nitrate aqueous solution was 0.01 mol/L and urea was 0.25 mol/L. The above was sufficiently mixed and then heating at 90 C with mixing was started.

(2) Yttrium nitrate aqueous solution with 1.0 mol/L was added to the aqueous solution of (1) at an adding rate of 1 mL each minute for 60 minutes.

(3) Nitrate aqueous solution including 0.1 mol/L of yttrium and 0.9 mol/L of cerium was added to the aqueous solution of (2) at an adding rate of 1 mL each minute for 60 minutes.

(4) The polishing material precursor particle deposited in the above (3) is separated with the membrane filter and baked at 1500 C for 3 hours, at a temperature increase/decrease rate of 25 C/min to obtain the secondary particle with 15000 nm.

(5) The secondary particle obtained in (4) is crushed to adjust the average particle size and the secondary particle with the average particle size of 2000 nm is obtained.

(6) The particle size distribution measurement is performed on the secondary particle obtained in (5) with the adjusted average particle size so that the distribution is adjusted to a similar particle size to enhance monodispersity (CV value).

### <Polishing Materials 20, 21>

The producing method of the polishing materials 20 and 21 is the same as the polishing material 19, except when the secondary particle is crushed in (5), the average particle size is adjusted to be a secondary particle at 5000 nm, 10000 nm, respectively.

### <Polishing Material 22>

(1) 0.5 L of urea aqueous solution with 5.0 mol/L is prepared and heated to 60 C.

(2) 180 mL of cerium nitrate aqueous solution with 1.0 mol/L is mixed with 20 mL of yttrium nitrate aqueous solution with 1.0 mol/L and then pure water is added to make 9.5 L of the mixed aqueous solution, and the mixed aqueous solution is heated to 90 C.

(3) Supply of carbon dioxide is started at a flow rate of 0.5 L/min and supply pressure of 0.1 Mpa to the mixed aqueous solution heated to 90 C in (2).

(4) When 15 minutes pass after the start of supply of carbon dioxide in (3), the urea aqueous solution prepared in (1) is added to the cerium nitrate aqueous solution heated to 90 C and supplied with carbon dioxide in (3) at an adding rate of 1 L/min.

(5) The reaction solution in which the urea aqueous solution is added in the cerium nitrate aqueous solution in (4) is heated and mixed at 90 C for 8 minutes.

(6) The precursor of the polishing material particle deposited in the reaction solution heated and mixed in (5) is separated with a membrane filter.

(7) The precursor of the polishing material particle separated in (6) is baked at 1500 C for 3 hours at a temperature increase/decrease rate of 25 C/min to obtain the secondary particle with 15000 nm.

(8) The secondary particle obtained in (7) is crushed to adjust the average particle size, and the secondary particle with the average particle size 150 nm is obtained.

(9) The particle size distribution measurement is performed on the secondary particle obtained in (8) with the adjusted average particle size so that the distribution is adjusted to a similar particle size to enhance monodispersity (CV value).

### <Polishing Materials 23 to 25>

The producing method of the polishing materials 23 to 25 is the same as the polishing material 1, except when the secondary particle is crushed in (8), the average particle size is adjusted to be a secondary particle at 250 nm, 5000 nm, 10000 nm, respectively.

<Polishing material 26>

(1) 0.5 L of urea aqueous solution with 5.0 mol/L is prepared and heated to 60 C.

(2) 180 mL of cerium nitrate aqueous solution with 1.0 mol/L is mixed with 20 mL of yttrium nitrate aqueous solution with 1.0 mol/L and then pure water is added to make 9.5 L of the mixed aqueous solution, and the mixed aqueous solution is heated to 90 C.

(3) Supply of carbon dioxide is started at a flow rate of 0.5 L/min and supply pressure of 0.1 Mpa to the mixed aqueous solution heated to 90 C in (2).

(4) When 15 minutes pass after the start of supply of carbon dioxide in (3), the urea aqueous solution prepared in (1) is added to the cerium nitrate aqueous solution heated to 90 C and supplied with carbon dioxide in (3) at an adding rate of 1 L/min.

(5) The reaction solution in which the urea aqueous solution is added in the cerium nitrate aqueous solution in (4) is heated and mixed at 90 C for 10 minutes.

(6) The precursor of the polishing material particle deposited in the reaction solution heated and mixed in (5) is separated with a membrane filter.

(7) The precursor of the polishing material particle separated in (6) is baked at 1500 C for 3 hours at a temperature increase/decrease rate of 25 C/min to obtain the secondary particle with 15000 nm.

(8) The secondary particle obtained in (7) is crushed to adjust the average particle size, and the secondary particle with the average particle size 150 nm is obtained.

(9) The particle size distribution measurement is performed on the secondary particle obtained in (8) with the adjusted average particle size so that the distribution is adjusted to a similar particle size to enhance monodispersity (CV value).

### <Polishing Materials 27 to 30>

The producing method of the polishing materials 27 to 30 is the same as the polishing material 26, except when the secondary particle is crushed in (8), the average particle size is adjusted to be a secondary particle at 300 nm, 1000 nm, 5000 nm, 10000 nm, respectively.

### <Polishing Material 31>

(1) 0.5 L of urea aqueous solution with 5.0 mol/L is prepared and heated to 60 C.

(2) 180 mL of cerium nitrate aqueous solution with 1.0 mol/L is mixed with 20 mL of yttrium nitrate aqueous solution with 1.0 mol/L and then pure water is added to make 9.5 L of the mixed aqueous solution, and the mixed aqueous solution is heated to 90 C.

(3) Supply of carbon dioxide is started at a flow rate of 0.5 L/min and supply pressure of 0.1 Mpa to the mixed aqueous solution heated to 90 C in (2).

(4) When 15 minutes pass after the start of supply of carbon dioxide in (3), the urea aqueous solution prepared in (1) is added to the cerium nitrate aqueous solution heated to 90 C and supplied with carbon dioxide in (3) at an adding rate of 1 L/min.

(5) The reaction solution in which the urea aqueous solution is added in the cerium nitrate aqueous solution in (4) is heated and mixed at 90 C for 50 minutes.

(6) The precursor of the polishing material particle deposited in the reaction solution heated and mixed in (5) is separated with a membrane filter.

(7) The precursor of the polishing material particle separated in (6) is baked at 1500 C for 3 hours at a temperature increase/decrease rate of 25 C/min to obtain the secondary particle with 15000 nm.

(8) The secondary particle obtained in (7) is crushed to adjust the average particle size, and the secondary particle with the average particle size 500 nm is obtained.

(9) The particle size distribution measurement is performed on the secondary particle obtained in (8) with the adjusted average particle size so that the distribution is adjusted to a similar particle size to enhance monodispersity (CV value).

### <Polishing Material 32>

(1) 0.5 L of urea aqueous solution with 5.0 mol/L is prepared and heated to 60 C.

(2) 180 mL of cerium nitrate aqueous solution with 1.0 mol/L is mixed with 20 mL of yttrium nitrate aqueous solution with 1.0 mol/L and then pure water is added to make 9.5 L of the mixed aqueous solution, and the mixed aqueous solution is heated to 90 C.

(3) Supply of carbon dioxide is started at a flow rate of 0.5 L/min and supply pressure of 0.1 Mpa to the mixed aqueous solution heated to 90 C in (2).

(4) When 15 minutes pass after the start of supply of carbon dioxide in (3), the urea aqueous solution prepared in (1) is added to the cerium nitrate aqueous solution heated to 90 C and supplied with carbon dioxide in (3) at an adding rate of 1 L/min.

(5) The reaction solution in which the urea aqueous solution is added in the cerium nitrate aqueous solution in (4) is heated and mixed at 90 C for 50 minutes.

(6) The precursor of the polishing material particle deposited in the reaction solution heated and mixed in (5) is separated with a membrane filter.

(7) The precursor of the polishing material particle separated in (6) is baked at 1500 C for 3 hours at a temperature increase/decrease rate of 25 C/min to obtain the secondary particle with 15000 nm.

(8) The secondary particle obtained in (7) is crushed to adjust the average particle size, and the secondary particle with the average particle size 500 nm is obtained.

### <Polishing Materials 33, 34>

The producing method of the polishing materials 33 and 34 is the same as the polishing material 31, except when the secondary particle is crushed in (8), the average particle size is adjusted to be a secondary particle at 5000 nm, 10000 nm, respectively.

### <Polishing Material 35>

(1) 0.5 L of urea aqueous solution with 5.0 mol/L is prepared and heated to 60 C.

(2) 180 mL of cerium nitrate aqueous solution with 1.0 mol/L is mixed with 20 mL of yttrium nitrate aqueous solution with 1.0 mol/L and then pure water is added to make 9.5 L of the mixed aqueous solution, and the mixed aqueous solution is heated to 90 C.

(3) Supply of carbon dioxide is started at a flow rate of 0.5 L/min and supply pressure of 0.1 Mpa to the mixed aqueous solution heated to 90 C in (2).

(4) When 15 minutes pass after the start of supply of carbon dioxide in (3), the urea aqueous solution prepared in (1) is added to the cerium nitrate aqueous solution heated to 90 C and supplied with carbon dioxide in (3) at an adding rate of 1 L/min.

(5) The reaction solution in which the urea aqueous solution is added in the cerium nitrate aqueous solution in (4) is heated and mixed at 90 C for 50 minutes.

(6) The precursor of the polishing material particle deposited in the reaction solution heated and mixed in (5) is separated with a membrane filter.

(7) The precursor of the polishing material particle separated in (6) is baked at 1500 C for 3 hours at a temperature increase/decrease rate of 25 C/min to obtain the secondary particle with 15000 nm.

(8) The secondary particle obtained in (7) is crushed to adjust the average particle size, and the secondary particle with the average particle size 10000 nm is obtained.

### <Polishing Material 36>

The producing method of the polishing material 36 is the same as the polishing material 31, except when the secondary particle is crushed in (8), the average particle size is adjusted to be a secondary particle at 15000 nm.

### <Polishing Material 37>

(1) 0.5 L of urea aqueous solution with 5.0 mol/L is prepared and heated to 60 C.

(2) 180 mL of cerium nitrate aqueous solution with 1.0 mol/L is mixed with 20 mL of yttrium nitrate aqueous solution with 1.0 mol/L and then pure water is added to make 9.5 L of the mixed aqueous solution, and the mixed aqueous solution is heated to 90 C.

(3) Supply of carbon dioxide is started at a flow rate of 0.5 L/min and supply pressure of 0.1 Mpa to the mixed aqueous solution heated to 90 C in (2).

(4) When 15 minutes pass after the start of supply of carbon dioxide in (3), the urea aqueous solution prepared in (1) is added to the cerium nitrate aqueous solution heated to 90 C and supplied with carbon dioxide in (3) at an adding rate of 1 L/min.

(5) The reaction solution in which the urea aqueous solution is added in the cerium nitrate aqueous solution in (4) is heated and mixed at 90 C for 100 minutes.

(6) The precursor of the polishing material particle deposited in the reaction solution heated and mixed in (5) is separated with a membrane filter.

(7) The precursor of the polishing material particle separated in (6) is baked at 1500 C for 3 hours at a temperature increase/decrease rate of 25 C/min to obtain the secondary particle with 15000 nm.

(8) The secondary particle obtained in (7) is crushed to adjust the average particle size, and the secondary particle with the average particle size 5000 nm is obtained.

(9) The particle size distribution measurement is performed on the secondary particle obtained in (8) with the adjusted average particle size so that the distribution is adjusted to a similar particle size to enhance monodispersity (CV value).

### <Polishing Materials 38, 39>

The producing method of the polishing materials 38 and 39 is the same as the polishing material 37, except when the secondary particle is crushed in (8), the average particle size is adjusted to be a secondary particle at 10000 nm, 15000 nm, respectively.

### <Polishing Material 40>

(1) 0.5 L of urea aqueous solution with 5.0 mol/L is prepared and heated to 60 C.

(2) 180 mL of cerium nitrate aqueous solution with 1.0 mol/L is mixed with 20 mL of yttrium nitrate aqueous solution with 1.0 mol/L and then pure water is added to make 9.5 L of the mixed aqueous solution, and the mixed aqueous solution is heated to 90 C.

(3) Supply of carbon dioxide is started at a flow rate of 0.5 L/min and supply pressure of 0.1 Mpa to the mixed aqueous solution heated to 90 C in (2).

(4) When 15 minutes pass after the start of supply of carbon dioxide in (3), the urea aqueous solution prepared in (1) is added to the cerium nitrate aqueous solution heated to 90 C and supplied with carbon dioxide in (3) at an adding rate of 1 L/min.

(5) The reaction solution in which the urea aqueous solution is added in the cerium nitrate aqueous solution in (4) is heated and mixed at 90 C for 2 hours.

(6) The precursor of the polishing material particle deposited in the reaction solution heated and mixed in (5) is separated with a membrane filter.

(7) The precursor of the polishing material particle separated in (6) is baked at 1500 C for 3 hours at a temperature increase/decrease rate of 25 C/min to obtain the secondary particle with 15000 nm.

(8) The secondary particle obtained in (7) is crushed to adjust the average particle size, and the secondary particle with the average particle size 2000 nm is obtained.

(9) The particle size distribution measurement is performed on the secondary particle obtained in (8) with the adjusted average particle size so that the distribution is adjusted to a similar particle size to enhance monodispersity (CV value).

### <Polishing Materials 41, 42>

The producing method of the polishing materials 41 and 42 is the same as the polishing material 40, except when the secondary particle is crushed in (8), the average particle size is adjusted to be a secondary particle at 5000 nm, 10000 nm, respectively.

### <Evaluation of Polishing Material>

The slurry in which the polishing materials 1 to 42 are dispersed in water is evaluated according to the method below in view of the shape and polishing properties.

### 1. Particle Shape, Aspect Ratio

A scanning electron microscopic picture (SEM image) of the polishing material particle is captured using the scanning electron microscope (SEM) S-37 of HITACHI, Ltd., 100 particles are randomly selected, and the average value a/b when the major axis is a and the minor axis is b is obtained as the aspect ratio. When a circumscribed rectangle of the particles is drawn, among the short sides and the long sides of the circumscribed rectangle, the length of the shortest short side is to be the minor axis, and the length of the longest long side is to be the major axis.

The shape is classified as a sphere shape when the aspect ratio is within the range of 1.00 to 1.15, preferably, 1.00 to 1.05. The shape is classified as an indeterminate form when outside the range of 1.00 to 1.15. It was confirmed that the primary particle included in the polishing materials 1 to 42 was a sphere shape.

### 2. Average Particle Size, Particle Size Variation Coefficient

Based on the square measure of the picture image of the particles from the SEM image of 20 polishing material precursor particles (primary particle), the particle size corresponding to the square measure circle is obtained. This is to be the particle size of the particles.

The average particle size is the arithmetic average value of the particle size of the 20 polishing material particles.

Moreover, the average particle size before and after the polishing process and the monodispersity of the secondary particle can be obtained using the particle size distribution measurement.

In the particle size distribution measurement, LA-950S2 of HORIBA, Ltd. is used, the secondary particle after crushing is dispersed in water and a suitable amount is put into the apparatus. It is known that when a laser hits a particle in the dispersion medium, the laser scatters at a refractive index and magnitude unique to the particle type (here, cerium) and particle size according to the light scattering theory. This principle can be used to calculate the average particle size before and after the polishing process.

The monodispersity of the secondary particle can be defined by the variation coefficient of the particle size distribution which can be calculated using the particle size obtained from the particle size distribution measurement.

The particle size distribution variation coefficient can be obtained by the following equation.

Variation coefficient (%)=(standard deviation of particle size distribution/average particle size)·100

The average particle size is the arithmetic average value of the particle size of the 100 polishing material particles.

### 3. Polishing Rate

The polishing rate was measured by supplying polishing material slurry in which powder of the polishing material using the polishing material particle is dispersed in the solvent such as water to the face of the polishing workpiece, and polishing the face of the polishing workpiece with the polishing cloth. The dispersion solvent of the polishing material slurry was only water, the concentration was 100 g/L, and the polishing material slurry passed a filter with a pore size of 5 mm. In the polishing test, the polishing slurry was supplied circulated in a flow rate of 5 L/min and the polishing process was performed. A glass substrate with 65 mmF was used as the polishing workpiece and polyurethane cloth was used as the polishing cloth. The pressure on the polishing face in polishing was 9.8 kPa (100 g/cm²), the rotating rate of the polishing tester was set to 100 min⁻¹ (rpm), and polishing was performed for 30 minutes. The thickness before and after polishing was measured with Nikon Digimicro (MF501). The polishing amount (mm) for each minute was calculated from the difference in thickness and this is to be the polishing rate.

The average polishing amount for 5 minutes after the start of the polishing process is calculated as the initial polishing rate, and the polishing amount for 5 minutes from 5 minutes before the polishing process ends to when the process ends can be calculated as the end polishing rate.

### 4. Scratch

Regarding the surface state (number of scratches) of the glass substrate surface, the number of scratches can be evaluated by measuring the unevenness of the entire surface of the glass substrate on which the polishing process is performed for 30 minutes using the light wave interference surface roughness measurement device (Dual-channel Zemapper manufactured by Zygo).

Specifically the surfaces of 5 glass substrates on which the polishing process is performed for 30 minutes are checked by sight for any scratches within the range of 50 to 100 mm using the Dual-channel Zemapper manufactured by Zygo and the average of the number of scratches on each substrate is shown.

### <Shape of Polishing Material, Evaluation of Polishing Performance>

The result obtained by the above evaluation is shown in tables 1 and 2.

TABLE 1

| | | | PRIMARY | SECONDARY | |
|---|---|---|---|---|---|
| | | | PARTICLE | PARTICLE | AVERAGE |
| | | | AVERAGE | AVERAGE | PARTICLE |
| POLISHING | | PRIMARY | PARTICLE | PARTICLE | SIZE AFTER |
| MATERIAL | LAYER | PARTICLE | SIZE | SIZE | POLISHING |
| NUMBER | CONFIGURATION | SHAPE | (nm) | (nm) | (nm) |
| 1 | TWO LAYERS | SPHERE SHAPE | 80 | 150 | 84 |
| 2 | TWO LAYERS | SPHERE SHAPE | 80 | 250 | 88 |
| 3 | TWO LAYERS | SPHERE SHAPE | 80 | 5000 | 82 |
| 4 | TWO LAYERS | SPHERE SHAPE | 80 | 10000 | 89 |
| 5 | TWO LAYERS | SPHERE SHAPE | 100 | 150 | 101 |
| 6 | TWO LAYERS | SPHERE SHAPE | 100 | 300 | 113 |
| 7 | TWO LAYERS | SPHERE SHAPE | 100 | 1000 | 105 |
| 8 | TWO LAYERS | SPHERE SHAPE | 100 | 5000 | 107 |
| 9 | TWO LAYERS | SPHERE SHAPE | 100 | 10000 | 110 |
| 10 | TWO LAYERS | SPHERE SHAPE | 500 | 1000 | 513 |
| 11 | TWO LAYERS | SPHERE SHAPE | 500 | 1000 | 511 |
| 12 | TWO LAYERS | SPHERE SHAPE | 500 | 5000 | 507 |
| 13 | TWO LAYERS | SPHERE SHAPE | 500 | 10000 | 505 |
| 14 | TWO LAYERS | SPHERE SHAPE | 500 | 10000 | 502 |
| 15 | TWO LAYERS | SPHERE SHAPE | 500 | 15000 | 519 |
| 16 | TWO LAYERS | SPHERE SHAPE | 1000 | 5000 | 1012 |
| 17 | TWO LAYERS | SPHERE SHAPE | 1000 | 10000 | 1032 |
| 18 | TWO LAYERS | SPHERE SHAPE | 1000 | 15000 | 1055 |
| 19 | TWO LAYERS | SPHERE SHAPE | 1200 | 2000 | 1333 |
| 20 | TWO LAYERS | SPHERE SHAPE | 1200 | 5000 | 1307 |
| 21 | TWO LAYERS | SPHERE SHAPE | 1200 | 10000 | 1342 |

| | | INITIAL | END | | |
|---|---|---|---|---|---|
| POLISHING | CV | POLISHING | POLISHING | | |
| MATERIAL | VALUE | RATE | RATE | NUMBER OF | |
| NUMBER | (%) | (μm/min) | (μm/min) | SCRATCHES | REMARKS |
| 1 | 6.4 | 0.37 | 0.01 | 0 | COMPARATIVE EXAMPLE |
| 2 | 6.2 | 0.39 | 0.02 | 1 | COMPARATIVE EXAMPLE |
| 3 | 7.9 | 1.12 | 0.03 | 0 | COMPARATIVE EXAMPLE |
| 4 | 9.1 | 1.38 | 0.02 | 1 | COMPARATIVE EXAMPLE |
| 5 | 6.7 | 0.41 | 0.22 | 0 | COMPARATIVE EXAMPLE |
| 6 | 5.2 | 0.57 | 0.27 | 0 | PRESENT INVENTION |
| 7 | 8.7 | 0.90 | 0.30 | 0 | PRESENT INVENTION |
| 8 | 7.1 | 1.17 | 0.31 | 1 | PRESENT INVENTION |
| 9 | 9.0 | 1.40 | 0.28 | 0 | PRESENT INVENTION |
| 10 | 4.5 | 0.87 | 0.63 | 3 | PRESENT INVENTION |
| 11 | 27.2 | 0.82 | 0.63 | 17 | PRESENT INVENTION |
| 12 | 6.5 | 1.22 | 0.77 | 7 | PRESENT INVENTION |
| 13 | 4.2 | 1.47 | 0.61 | 8 | PRESENT INVENTION |
| 14 | 34.2 | 1.43 | 0.59 | 19 | PRESENT INVENTION |
| 15 | 7.7 | 1.60 | 0.72 | 41 | COMPARATIVE EXAMPLE |
| 16 | 6.7 | 1.25 | 0.80 | 2 | PRESENT INVENTION |
| 17 | 7.8 | 1.50 | 0.84 | 5 | PRESENT INVENTION |
| 18 | 8.9 | 1.66 | 0.87 | 43 | COMPARATIVE EXAMPLE |
| 19 | 6.4 | 1.12 | 0.91 | 31 | COMPARATIVE EXAMPLE |
| 20 | 7.1 | 1.28 | 0.95 | 38 | COMPARATIVE EXAMPLE |
| 21 | 7.7 | 1.56 | 0.99 | 54 | COMPARATIVE EXAMPLE |

TABLE 2

| | | | PRIMARY | SECONDARY | |
|---|---|---|---|---|---|
| | | | PARTICLE | PARTICLE | AVERAGE |
| | | | AVERAGE | AVERAGE | PARTICLE |
| POLISHING | | PRIMARY | PARTICLE | PARTICLE | SIZE AFTER |
| MATERIAL | LAYER | PARTICLE | SIZE | SIZE | POLISHING |
| NUMBER | CONFIGURATION | SHAPE | (nm) | (nm) | (nm) |
| 22 | ONE LAYER | SPHERE SHAPE | 80 | 150 | 84 |
| 23 | ONE LAYER | SPHERE SHAPE | 80 | 250 | 80 |
| 24 | ONE LAYER | SPHERE SHAPE | 80 | 5000 | 83 |
| 25 | ONE LAYER | SPHERE SHAPE | 80 | 10000 | 85 |
| 26 | ONE LAYER | SPHERE SHAPE | 100 | 150 | 111 |
| 27 | ONE LAYER | SPHERE SHAPE | 100 | 300 | 105 |
| 28 | ONE LAYER | SPHERE SHAPE | 100 | 1000 | 106 |
| 29 | ONE LAYER | SPHERE SHAPE | 100 | 5000 | 109 |
| 30 | ONE LAYER | SPHERE SHAPE | 100 | 10000 | 106 |
| 31 | ONE LAYER | SPHERE SHAPE | 500 | 1000 | 511 |
| 32 | ONE LAYER | SPHERE SHAPE | 500 | 1000 | 514 |
| 33 | ONE LAYER | SPHERE SHAPE | 500 | 5000 | 522 |
| 34 | ONE LAYER | SPHERE SHAPE | 500 | 10000 | 513 |
| 35 | ONE LAYER | SPHERE SHAPE | 500 | 10000 | 511 |
| 36 | ONE LAYER | SPHERE SHAPE | 500 | 15000 | 518 |
| 37 | ONE LAYER | SPHERE SHAPE | 1000 | 5000 | 1003 |
| 38 | ONE LAYER | SPHERE SHAPE | 1000 | 10000 | 1006 |
| 39 | ONE LAYER | SPHERE SHAPE | 1000 | 15000 | 1032 |
| 40 | ONE LAYER | SPHERE SHAPE | 1200 | 2000 | 1234 |
| 41 | ONE LAYER | SPHERE SHAPE | 1200 | 5000 | 1267 |
| 42 | ONE LAYER | SPHERE SHAPE | 1200 | 10000 | 1289 |

| | | INITIAL | END | | |
|---|---|---|---|---|---|
| POLISHING | CV | POLISHING | POLISHING | | |
| MATERIAL | VALUE | RATE | RATE | NUMBER OF | |
| NUMBER | (%) | (μm/min) | (μm/min) | SCRATCHES | REMARKS |
| 22 | 6.1 | 0.36 | 0.02 | 1 | COMPARATIVE EXAMPLE |
| 23 | 7.9 | 0.41 | 0.01 | 1 | COMPARATIVE EXAMPLE |
| 24 | 9.0 | 1.10 | 0.02 | 0 | COMPARATIVE EXAMPLE |
| 25 | 6.3 | 1.35 | 0.03 | 0 | COMPARATIVE EXAMPLE |
| 26 | 8.6 | 0.38 | 0.22 | 0 | COMPARATIVE EXAMPLE |
| 27 | 5.5 | 0.54 | 0.27 | 0 | COMPARATIVE EXAMPLE |
| 28 | 9.1 | 0.78 | 0.30 | 0 | PRESENT INVENTION |
| 29 | 7.9 | 0.90 | 0.31 | 1 | PRESENT INVENTION |
| 30 | 8.1 | 1.17 | 0.28 | 0 | PRESENT INVENTION |
| 31 | 4.5 | 0.82 | 0.61 | 2 | PRESENT INVENTION |
| 32 | 28.8 | 0.81 | 0.63 | 17 | PRESENT INVENTION |
| 33 | 6.5 | 1.17 | 0.65 | 5 | PRESENT INVENTION |
| 34 | 4.3 | 1.44 | 0.52 | 6 | PRESENT INVENTION |
| 35 | 35.0 | 1.41 | 0.58 | 18 | PRESENT INVENTION |
| 36 | 8.1 | 1.57 | 0.54 | 44 | COMPARATIVE EXAMPLE |
| 37 | 6.5 | 1.30 | 0.80 | 2 | PRESENT INVENTION |
| 38 | 7.7 | 1.42 | 0.85 | 5 | PRESENT INVENTION |
| 39 | 9.3 | 1.62 | 0.87 | 43 | COMPARATIVE EXAMPLE |
| 40 | 6.1 | 1.12 | 0.94 | 35 | COMPARATIVE EXAMPLE |
| 41 | 7.2 | 1.24 | 0.93 | 33 | COMPARATIVE EXAMPLE |
| 42 | 7.3 | 1.50 | 0.96 | 47 | COMPARATIVE EXAMPLE |

As can be seen from tables 1 and 2, among the polishing materials 1 to 42, the polishing material including the polishing material particle in which the average particle size of the primary particle is within the range of 100 to 1000 nm and the average particle size of the secondary particle is within the range of 300 to 10000 nm has a faster polishing rate and the scratches are suppressed more than the polishing material outside the above range.

### INDUSTRIAL APPLICABILITY

The present invention can be used in the field of performing polishing with a polishing material containing cerium oxide in the process of producing, for example, glass products, semiconductor devices, and crystal oscillators.

1. A polishing material comprising:
a polishing material particle including cerium,
wherein, the polishing material particle is a secondary particle obtained by baking a primary particle which is a polishing material precursor particle;
the primary particle is a sphere shape;
an average particle size of the primary particle is within a range of 100 to 1000 nm; and
an average particle size of the secondary particle is within a range of 300 to 10000 nm.

2. The polishing material of claim 1, wherein a particle size variation coefficient of the polishing material particle included in the polishing material is 25% or less.

3. Polishing material slurry including polishing material according to claim 1.

4. Polishing material slurry including polishing material according to claim 2.
